(19) United States
(12) Patent Application Publication
(10) Pub. No.: US 2023/0386398 A1
(43) Pub. Date: Nov. 30, 2023

(54) LIGHT-EMITTING DIODE DRIVER, LIGHT-EMITTING MODULE, AND DISPLAY DEVICE FOR HIGH-RESOLUTION DIMMING

(71) Applicant: WELLANG CO., LTD., Gyeonggi-do (KR)

(72) Inventors: Jong Tae HWANG, Seoul (KR); Sung Hun Cho, Gyeonggi-do (KR)

(73) Assignee: WELLANG CO., LTD., Gyeonggi-do (KR)

(21) Appl. No.: 18/324,625

(22) Filed: May 26, 2023

(30) Foreign Application Priority Data
May 31, 2022 (KR) 10-2022-0066912

(51) Int. Cl. G09G 3/32

(52) U.S. Cl. CPC G09G 3/32; G09G 2310/08; G09G 2310/0264

(57) ABSTRACT

Aspects of the subject disclosure may include, for example, a light-emitting diode (LED) driver configured to generate an LED driving current based on an input signal. The LED driver includes a code generator configured to generate code such that the LED driving current includes a direct current component corresponding to an upper n-bit of the input signal and an alternating current component alternating according to a lower m-bit of the input signal, and a current generator configured to generate the LED driving current, based on the code. Other embodiments are disclosed.

### CROSS-REFERENCE TO RELATED APPLICATION

This application is based on and claims priority under 35 U.S.C. § 119 to Korean Patent Application No. 10-2022-0066912, filed on May 31, 2022, in the Korean Intellectual Property Office, the disclosure of which is incorporated by reference herein in its entirety.

### BACKGROUND

### 1. Field

The disclosure relates to driving of a light-emitting diode (LED), and more particularly, to an LED driver, a light-emitting module, and a display device for high-resolution dimming.

### 2. Description of the Related Art

A light-emitting diode (LED) is used for various applications according to its advantageous characteristics, such as low power consumption and a small size. For example, an LED may be used as a backlight of a display. As an example of using an LED as a backlight, a mini LED may be used by closely arranging LEDs having small sizes (e.g., hundreds of m) and adjusting brightness of the LEDs according to display content. Performance of a display may be increased when resolution of such local dimming is increased.

### SUMMARY

Provided are a light-emitting diode (LED) driver, a light-emitting module, and a display device, which enable high-resolution dimming.

Additional aspects will be set forth in part in the description which follows and, in part, will be apparent from the description, or may be learned by practice of the presented embodiments of the disclosure.

According to an aspect of the disclosure, a light-emitting diode (LED) driver configured to generate an LED driving current, based on an input signal, includes a code generator configured to generate a code such that the LED driving current includes a direct current component corresponding to an upper n-bit of the input signal and an alternating current component alternating according to a lower m-bit of the input signal, and a current generator configured to generate the LED driving current, based on the code, wherein the input signal is an (m+n)-bit signal when each of m and n is an integer greater than zero.

The alternating current component may include at least one pulse during a first period, according to the lower m-bit, and the code generator may include a bit generator configured to generate a bit signal defining the at least one pulse from the lower m-bit, based on a clock signal.

A sum of widths of the at least one pulse may be constant for each first period.

A sum of widths of the at least one pulse may change during a second period including two or more first periods.

The sum of the widths of the at least one pulse may include a first portion that changes according to a lower k-bit among the lower m-bit, and a second portion that is constant according to an upper (m-k)-bit among the lower m-bit.

The code generator may include an adder configured to generate the code of (n+1)-bit by adding the upper n-bit and the bit signal.

The code may include the upper n-bit and the bit signal, the current generator may include a first current source configured to generate a first current corresponding to the upper n-bit, and a second current source configured to generate a second current corresponding to the bit signal, and the LED driving current may correspond to a sum of the first current and the second current.

According to another aspect of the disclosure, a method of driving a light-emitting diode (LED), based on an input signal, includes generating a code such that an LED driving current includes a direct current component corresponding to an upper n-bit of the input signal and an alternating current component alternating according to a lower m-bit of the input signal, and generating the LED driving current, based on the code, wherein each of n and m is an integer greater than zero, and the input signal is an (n+m)-bit signal.

The alternating current component may include at least one pulse during a first period, according to the lower m-bit, and the generating of the code may include generating a bit signal defining the at least one pulse from the lower m-bit based on a clock signal.

The generating of the code may further include adding the upper n-bit and the bit signal.

The generating of the code may further include generating the code by concatenating the upper n-bit and the bit signal, and the generating of the LED driving current may include generating a first current corresponding to the upper n-bit, generating a second current corresponding to the bit signal, and adding the first current and the second current.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of a system according to an embodiment of the disclosure;

FIG. 2A shows one example of a light-emitting diode (LED) driver according to comparative examples;

FIG. 2B shows another example of the light-emitting diode (LED) driver according to comparative examples;

FIG. 3A is a diagram showing one example of operations of a code generator according to embodiments of the disclosure;

FIG. 3B is a diagram showing another example of operations of the code generator according to embodiments of the disclosure;

FIG. 4A is a timing diagram showing one example of operations of a bit generator according to embodiments of the disclosure;

FIG. 4B is a timing diagram showing another example of operations of the bit generator according to embodiments of the disclosure;

FIG. 5 is a diagram showing an LED driving current corresponding to an input signal, according to an embodiment of the disclosure;

FIG. 6 is a diagram of a display device according to an embodiment of the disclosure;

FIG. 7A is a timing diagram showing one example of an LED driving current for driving LEDs included in a backlight unit of FIG. 6;

FIG. 7B is a timing diagram showing another example of the LED driving current for driving LEDs included in the backlight unit of FIG. 6;

FIG. 8A is a diagram showing one example of a current generator according to embodiments of the disclosure;

FIG. 8B is a diagram showing another example of the current generator according to embodiments of the disclosure;

FIG. 9A is a diagram showing one example of an LED driver according to embodiments of the disclosure;

FIG. 9B is a diagram showing another example of the LED driver according to embodiments of the disclosure;

FIG. 10A is a diagram showing one example of operations of a code generator according to embodiments of the disclosure;

FIG. 10B is a diagram showing another example of operations of the code generator according to embodiments of the disclosure;

FIG. 11 is a timing diagram showing an example of operations of a bit generator, according to an embodiment of the disclosure;

FIG. 12 is a diagram showing a bit generator according to an embodiment of the disclosure;

FIG. 13 is a flowchart of a method for high-resolution dimming, according to an embodiment of the disclosure; and

FIG. 14A is a flowchart of one exemplary method for high-resolution dimming according to embodiments of the disclosure;

FIG. 14B is a flowchart of another exemplary method for high-resolution dimming according to embodiments of the disclosure.

### DETAILED DESCRIPTION

Hereinafter, embodiments of the disclosure will be described in detail with reference to accompanying drawings. The embodiments of the disclosure are provided to fully describe the disclosure to one of ordinary skill in the art. The disclosure may have various modifications and various embodiments, and specific embodiments are illustrated in the drawings and are described in detail. However, this is not intended to limit the disclosure to particular modes of practice, and it will be understood that all changes, equivalents, and substitutes that do not depart from the spirit and technical scope of the disclosure are encompassed in the disclosure. While describing the drawings, like reference numerals will be used for like components. In the accompanying drawings, dimensions of structures may be exaggerated or reduced for clarity of the disclosure.

Also, the terms used in the present specification are only used to describe specific embodiments, and are not intended to limit the disclosure. An expression used in the singular encompasses the expression in the plural unless it has a clearly different meaning in the context. In the present specification, it is to be understood that terms such as “including” or “having”, etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Unless otherwise defined, terms used herein, including technical or scientific terms, may have the same meaning as commonly understood by one of ordinary skill in the art described in the disclosure. Terms that are defined in commonly used dictionaries should be interpreted as having meanings consistent with those in the context of the related art, and should not be interpreted in ideal or excessively formal meanings unless clearly defined in the present application.

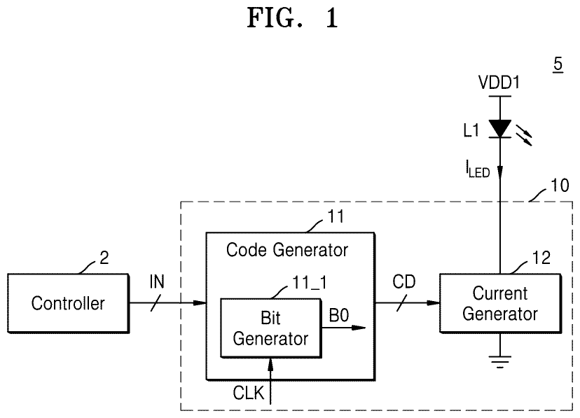

FIG. 1 is a block diagram of a system 5 according to an embodiment of the disclosure. As shown in FIG. 1, the system 5 may include a light-emitting diode (LED) L1, a controller 2, and an LED driver 10. According to some embodiments, the LED L1 of FIG. 1 may correspond to two or more LEDs connected to each other in series and/or parallel. According to some embodiments, the controller 2 and the LED driver 10 may be manufactured through semiconductor processes and may be included in at least one semiconductor package. According to some embodiments, the system 5 may include a printed circuit board (PCB), and the at least one semiconductor package may be mounted on the PCB.

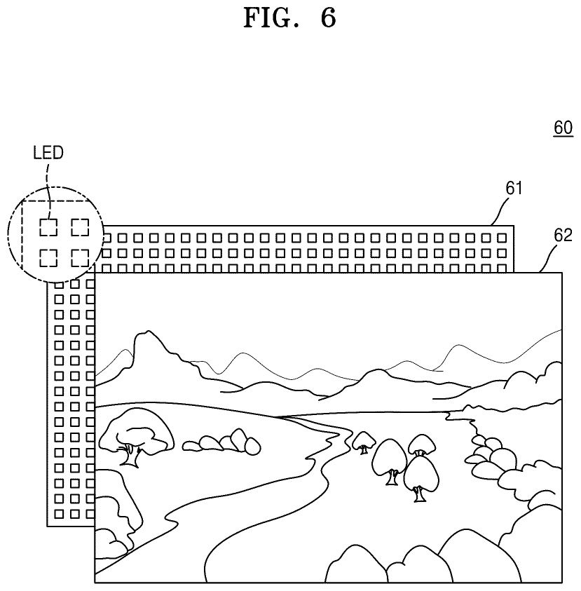

The system 5 may be any system using light emitted through the LED L1. According to some embodiments, the system 5 may be a lighting device, such as an indoor lamp, an outdoor lamp, a portable lamp, a vehicle lamp, or an independently distributed lamp. According to some embodiments, as will be described below with reference to FIG. 6, the system 5 may be a display device and the LED L1 may provide a backlight of the display device.

The controller 2 may generate an input signal IN to adjust intensity of the light emitted through the LED L1, and provide the input signal IN to the LED driver 10. The input signal IN may be a multi-bit signal, and a value of the input signal IN may indicate the intensity of light emitted through the LED L1. In other words, the value of the input signal IN may correspond to a dimming level, and when a bit count of the input signal IN is increased, dimming resolution may also increase. According to some embodiments, the system 5 may be a lighting device, and the controller 2 may generate the input signal IN, based on a signal received from the outside of the system 5, for example, through a wireless channel. According to some embodiments, the system 5 may be a display device, and the controller 2 may generate the input signal IN, based on information of image displayed. The controller 2 may include at least one of a programmable component such as a microcontroller, a reconfigurable component such as a field programmable gate array (FPGA), and a component providing a fixed function, such as a hardware intellectual property (IP).

The LED driver 10 may receive the input signal IN from the controller 2 and generate an LED driving current I_{LED}. The LED driver 10 may generate the LED driving current I_{LED} having a magnitude corresponding to the value of the input signal IN, and the LED L1 may emit light of intensity corresponding to the magnitude of the LED driving current I_{LED}. As shown in FIG. 1, the LED driving current I_{LED} may flow from a first positive supply voltage VDD1 to the LED driver 10 through the LED L1. According to some embodiments, unlike as shown in FIG. 1, the LED driver 10 may be provided between the first positive supply voltage VDD1 and the LED L1, and provide the LED driving current I_{LED} to the LED L1 connected to ground potential. As shown in FIG. 1, the LED driver 10 may include a code generator 11 and a current generator 12.

The code generator 11 may receive the input signal IN and generate code CD. According to some embodiments, a bit count of the code CD may be lower than the bit count of the input signal IN. According to some embodiments, the code generator 11 may generate the code CD such that the LED driving current I_{LED} includes a direct current component corresponding to at least one upper bit of the input signal IN, and an alternating current component alternating according to at least one lower bit of the input signal IN. For example, a value of the code CD may change on a time axis according to the value of the input signal IN. As shown in FIG. 1, the code generator 11 may include a bit generator 11_1 receiving a clock signal CLK, and the bit generator 11_1 may generate a bit signal B0 changing on the time axis, based on at least one bit of the input signal IN. The code CD may be generated based on the bit signal B0, and the bit signal B0 may generate the alternating current component of the LED driving current I_{LED}. Accordingly, the LED driving current I_{LED} accurately corresponding to the value of the input signal IN may be generated regardless of a high bit count of the input signal IN, and as a result, high-resolution dimming may be achieved. The bit generator 11_1 may have any structure that performs the above-described operation. For example, the bit generator 11_1 may include a plurality of logic gates, and may be referred to as a bit generation circuit.

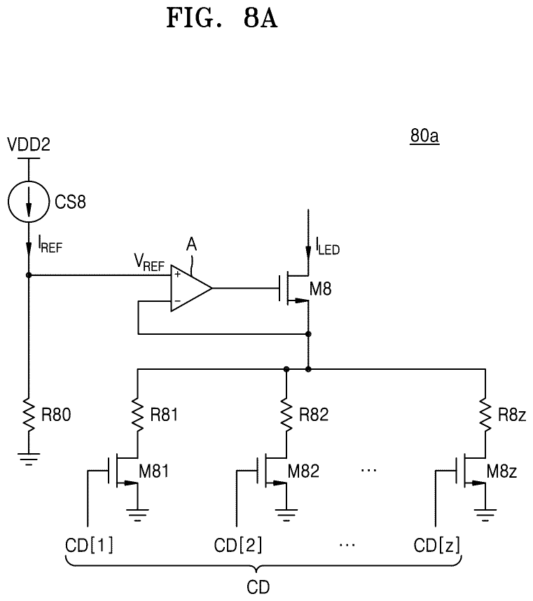

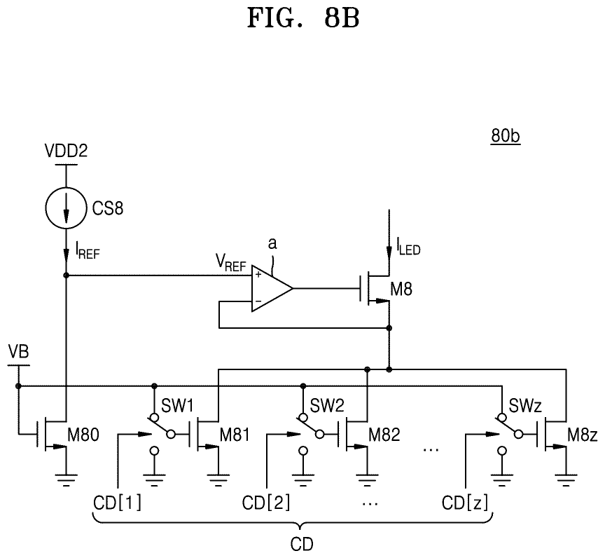

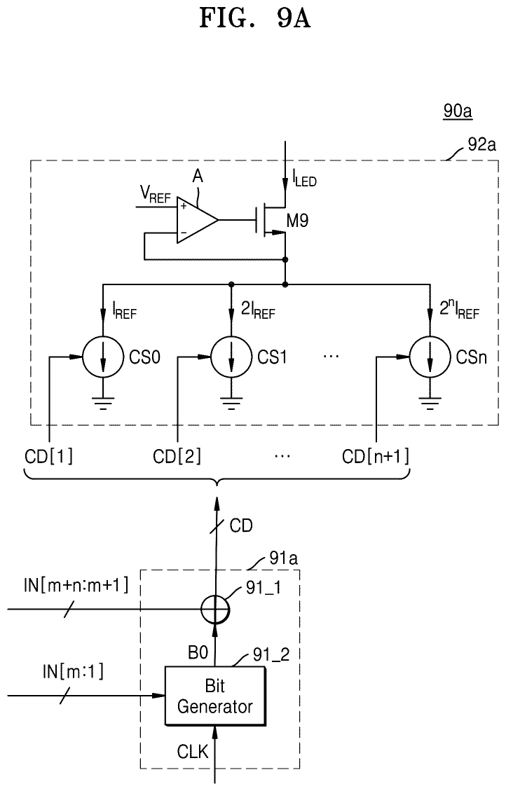

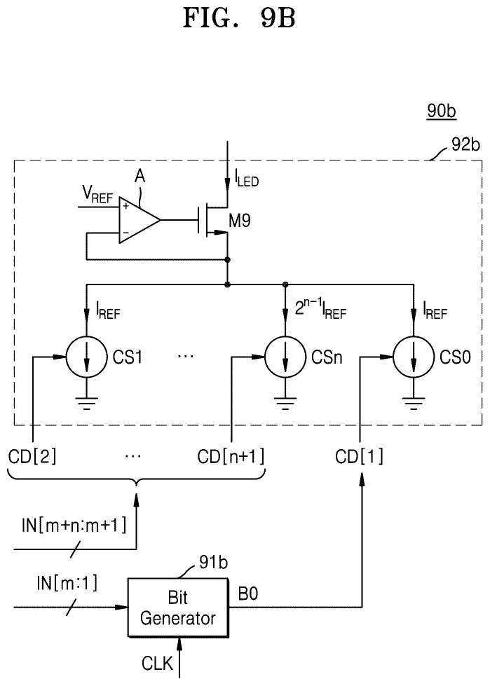

The current generator 12 may receive the code CD and generate the LED driving current I_{LED}, based on the code CD. According to some embodiments, the current generator 12 may include current sources respectively corresponding to bits of the code CD. Examples of the current generator 12 will be described below with reference to FIGS. 8A, 8B, 9A, and 9B.

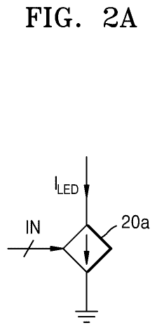

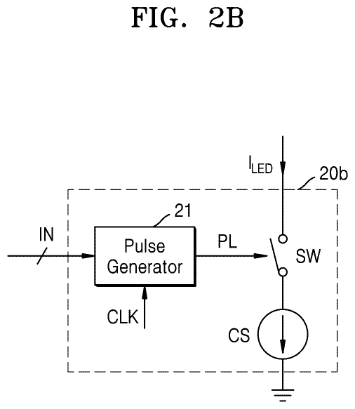

FIGS. 2A and 2B are diagrams showing examples of LED drivers according to comparative examples. As described above with reference to FIG. 1, the input signal IN may be a multi-bit signal and have a value corresponding to a dimming level, in FIGS. 2A and 2B.

Referring to FIG. 2A, the LED driver 20a may directly receive the input signal IN, and generate the LED driving current I_{LED} having a magnitude corresponding to the value of the input signal IN. For example, the LED driver 20a may include current sources respectively corresponding to the bits of the input signal IN, and each of the current sources may be enabled or disabled according to a bit of the input signal IN. The LED driving current I_{LED} may correspond to a sum of currents generated by at least one enabled current source. Accordingly, the LED driver 20a may generate the LED driving current I_{LED} having the magnitude proportional to the value of the input signal IN.

The current sources of the LED driver 20a may generate currents of different magnitudes. For example, when a magnitude of a current generated by a current source corresponding to a least significant bit (LSB) of the input signal IN is I1 and the bit count of the input signal IN is x, a magnitude of a current generated by a current source corresponding to a most significant bit (MSB) of the input signal IN may correspond to 2^{(x-1)}*I1 (x is an integer greater than 1). It may be required for each current source to generate a current of an accurate magnitude, and accordingly, the current source may include devices of a same size, and a magnitude of a current may be determined according to the number of devices included in the current source. Accordingly, when the bit count of the input signal IN is increased by 1, the area of the LED driver 20a may be increased approximately two times, and as a result, it may not be easy to realize high-resolution dimming by using the LED driver 20a.

Referring to FIG. 2B, the LED driver 20b may include a pulse generator 21, a switch SW, and a current source CS. The pulse generator 21 may generate a pulse signal PL from the input signal IN, based on the clock signal CLK. The pulse generator 21 may perform pulse width modulation (PWM), and accordingly, the pulse signal PL may include a pulse having a width corresponding to the value of the input signal IN. The switch SW may be turned on in response to the activated pulse signal PL (i.e., a pulse), and enable the current source CS to drain the LED driving current I_{LED} from an LED. On the other hand, the switch SW may be turned off in response to the deactivated pulse signal PL, and block the current source CS from the LED. Accordingly, an average magnitude of the LED driving current I_{LED} on the time axis may correspond to the value of the input signal IN.

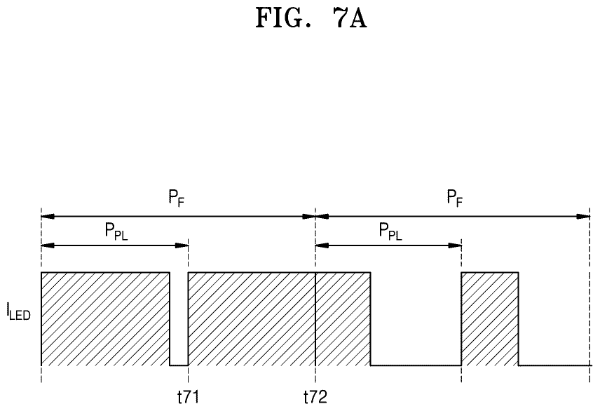

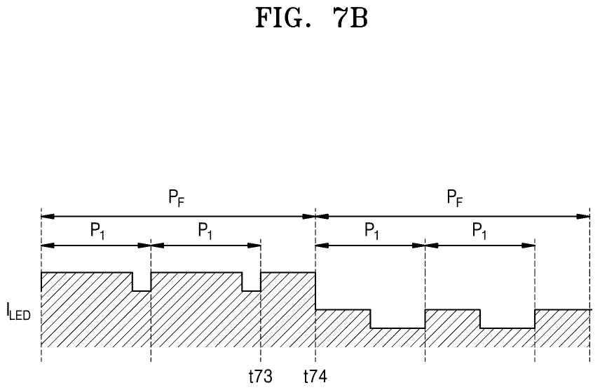

Compared to the LED driver 20a of FIG. 2A, even when the bit count of the input signal IN, i.e., the dimming resolution, is increased, an increase in the area of the LED driver 20b of FIG. 2B may not be remarkable. However, due to the LED driving current I_{LED} oscillating between zero and a peak, a serious power loss caused by parasitic components may occur, and thus an electromagnetic interference (EMI) issue may occur. Also, when an increase in a frequency of the clock signal CLK is limited, a period of the pulse signal PL may extend as the bit count of the input signal IN is increased, and thus flicker, in which on/off of the LED is visually recognizable, may occur or intensify. In particular, as will be described below with reference to FIG. 7A, dimming accuracy of a display device may deteriorate due to the extended period of the pulse signal PL.

Hereinafter, as will be described with reference to the drawings, the LED driver 10 of FIG. 1 may accurately generate the LED driving current I_{LED} corresponding to the value of the input signal IN of a high bit count. Also, an increase in the area of the LED driver 10 may be limited despite an increase in the bit count of the input signal IN. In addition, the LED driving current I_{LED} may not oscillate between zero and a peak, and thus a power loss and an EMI issue may be removed. Also, the LED driving current I_{LED} may include an alternating current component of a shortened period, and accordingly, a flicker characteristic may be improved in the system 5 and deterioration of the dimming accuracy may be prevented.

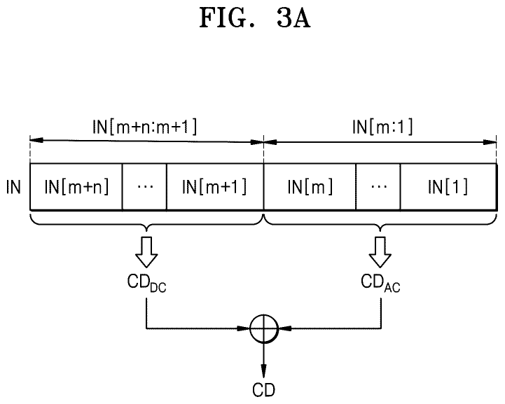

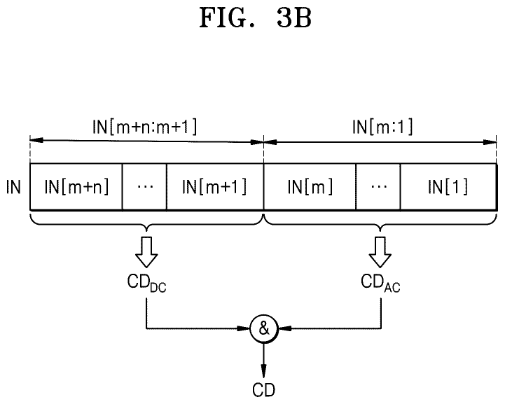

FIGS. 3A and 3B are diagrams showing examples of operations of the code generator 11, according to embodiments of the disclosure. As described above with reference to FIG. 1, the code generator 11 may generate the code CD from the input signal IN. Hereinafter, m and n may each be a positive integer and the bit count of the input signal IN may be m+n. FIGS. 3A and 3B will be described with reference to FIG. 1.

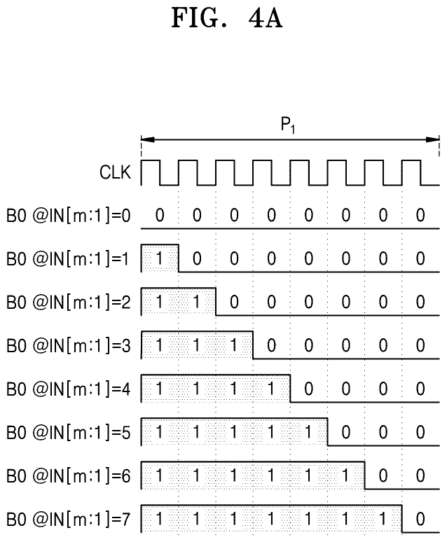

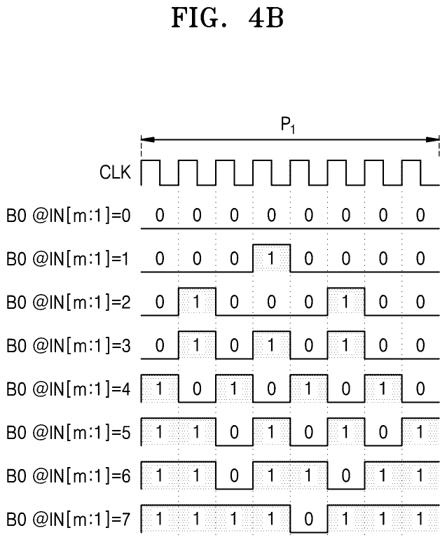

The code generator 11 may generate a first portion CD_{DC} corresponding to the direct current component of the LED driving current I_{LED}, based on an upper n-bit including the MSB of the input signal IN. For example, as shown in FIGS. 3A and 3B, the code generator 11 may generate the first portion CD_{DC} from the upper n-bit of the input signal IN, i.e., IN[m+n:m+1]. Also, the code generator 11 may generate a second portion CD_{AC} corresponding to the alternating current component of the LED driving current I_{LED}, based on a lower m-bit including the LSB of the input signal IN. For example, as shown in FIGS. 3A and 3B, the code generator 11 may generate the second portion CD_{AC} from the lower m-bit of the input signal IN, i.e., IN[m:1]. The second portion CD_{AC} may be 1-bit, and may correspond to the bit signal B0 generated by the bit generator 11_1. Examples of the bit signal B0 according to a value of the lower m-bit of the input signal IN will be described below with reference to FIGS. 4A and 4B.

The code generator 11 may generate the code CD, based on the first portion CD_{DC} and the second portion CD_{AC}. According to some embodiments, as shown in FIG. 3A, the code generator 11 may generate the code CD by adding the first portion CD_{DC} and the second portion CD_{AC}. According to some embodiments, as shown in FIG. 3B, the code generator 11 may generate the code CD by concatenating the first portion CD_{DC} and the second portion CD_{AC}. Accordingly, the code CD may have a bit count lower than the input signal IN, and the current generator 12 may have a structure simpler than and the area smaller than the LED driver 20a of FIG. 2A.

FIGS. 4A and 4B are timing diagrams showing examples of operations of the bit generator 11_1, according to embodiments of the disclosure. In detail, the timing diagrams of FIGS. 4A and 4B illustrate examples of operations of the bit generator 11_1 of FIG. 1, which generates the bit signal B0 corresponding to the alternating current component of the LED driving current I_{LED}, based on the lower m-bit of the input signal IN (i.e., IN[m:1]), as described above with reference to FIGS. 3A and 3B. For convenience of illustration, m may be 3 and the bit generator 11_1 may generate the bit signal B0 iterated every first period P₁ including 8 cycles of the clock signal CLK, in FIGS. 4A and 4B. It should be noted that the operations of the bit generator 11_1 are not limited by the examples of FIGS. 4A and 4B. Hereinafter, FIGS. 4A and 4B will be described with reference to FIG. 1.

Referring to FIG. 4A, the bit generator 11_1 may generate the bit signal B0 including a pulse having a width corresponding to a value of the lower m-bit of the input signal IN. For example, when the lower m-bit of the input signal IN is zero (IN[m:1]=0), the bit signal B0 may be zero for the first period P₁ and the pulse may not be generated. When the lower m-bit of the input signal IN is greater than zero (IN[m:1]>0), the bit signal B0 may be one for the number of consecutive clock cycles, which corresponds to the value of the lower m-bit of the input signal IN, and accordingly, a single pulse may be generated for the first period P₁.

Referring to FIG. 4B, the bit generator 11_1 may generate the bit signal B0 including at least one pulse, in which a sum of widths thereof corresponds to the value of the lower m-bit of the input signal IN. For example, when the lower m-bit of the input signal IN is zero (IN[m:1]=0), the bit signal B0 may be zero for the first period P₁ and the pulse may not be generated. When the lower m-bit of the input signal IN is greater than zero (IN[m:1]>0), at least one pulse may be generated in the first period P₁, and the value of the lower m-bit of the input signal IN may correspond to a sum of widths of the at least one pulse.

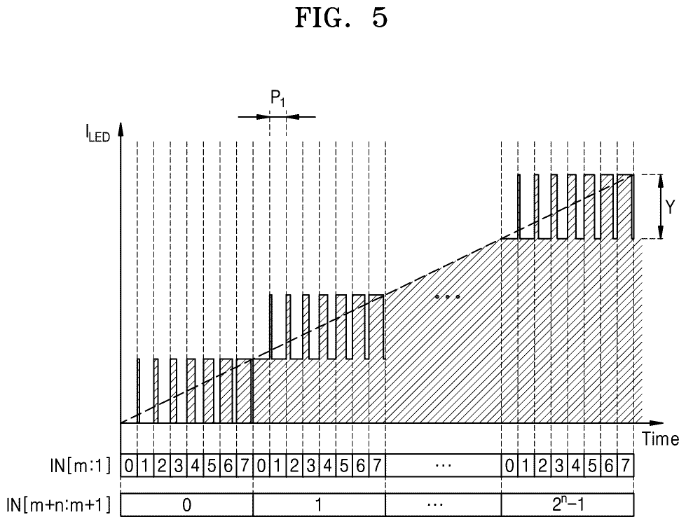

FIG. 5 is a diagram showing an LED driving current I_{LED} corresponding to the input signal IN, according to an embodiment of the disclosure. In detail, FIG. 5 illustrates the LED driving current I_{LED} according to the value of the input signal IN, which increases gradually, in units of first periods P₁.

Referring to FIG. 5, the LED driving current I_{LED} may include the direct current component corresponding to the upper n-bit of the input signal IN, and the alternating current component corresponding to the lower m-bit of the input signal IN. The LED driving current I_{LED} may increase as the value of the input signal IN is increased according to the direct current component, as shown in the example of FIG. 2A. Also, the LED driving current I_{LED} may oscillate at a low amplitude Y instead of oscillating between zero and a peak as shown in the example of FIG. 2B, and the first period P₁ may be much shorter than a period of the pulse signal PL of FIG. 2B. Accordingly, leakage power and an EMI issue may be resolved.

FIG. 6 is a diagram of a display device 60 according to an embodiment of the disclosure. In detail, FIG. 6 separately illustrates a blacklight unit (BLU) 61 and a color panel 62, which are included in a display panel of the display device 60, for convenience of illustration.

The display device 60 may refer to any device that outputs content, i.e., an image or a moving image, through the display panel. For example, the display device 60 may be an independent device for displaying, such as a television (TV) or a monitor, or may be included in a system as a component for a function that requires a display, such as a display of a smartphone or a cluster of a vehicle. The display device 60 may output content in any manner using the BLU 61. For example, the BLU 61 and the color panel 62 may be included in a liquid crystal display (LCD), and the color panel 62 may include a polarizing plate, a thin-film transistor (TFT), a liquid crystal, and a color filter.

The BLU 61 may include a plurality of LEDs as light sources. For example, as shown in FIG. 6, the BLU 61 may include the plurality of LEDs arranged in the form of an array. Lights emitted from the LEDs of the BLU 61 may be output by being combined to a color corresponding to the content by the color panel 62. A mini LED may be used by closely arranging the LEDs in the BLU 61, which have small sizes (e.g., hundreds of m) and adjusting brightness of a local dimming zone including at least one LED, i.e., intensity of light output from the local dimming zone, according to the content. Such a mini LED may resolve a low contrast ratio of an LCD, and accordingly, a high-quality and low-cost display device may be enabled. As described above with reference to the drawings, the LED driver 10 of FIG. 1 may provide high-resolution dimming, and accordingly, the display device 60 may further exquisitely display the content.

FIGS. 7A and 7B are timing diagrams showing examples of the LED driving current I_{LED} for driving the LEDs included in the BLU 61 of FIG. 6. In detail, FIG. 7A illustrates the LED driving current I_{LED} by the LED driver 20b of FIG. 2B, and FIG. 7B illustrates the LED driving current I_{LED} by the LED driver 10 of FIG. 1. In FIGS. 7A and 7B, for convenience of illustration, periods P_{PL} and P₁ are exaggerated. Hereinafter, FIGS. 7A and 7B will be described with reference to FIGS. 1, 2B, and 6.

Referring to FIG. 7A, an image displayed through the display device 60 may be updated every frame period P_{F}. Accordingly, the BLU 61 may also update a dimming level every frame period P_{F}. As described above with reference to FIG. 2B,when the bit count of the input signal IN is increased, the period of the pulse signal PL may be extended, and accordingly, a multiple of the period of the pulse signal PL may not be the same as the frame period P_{F}. For example, as shown in FIG. 7A, the frame period P_{F} may end at a time t72 before the period P_{PL} of the pulse signal PL elapses from a time t71. Accordingly, a peak may be maintained up to the next second frame period P_{F} while the LED driving current I_{LED} is not decreased to zero, and as a result, an average of the LED driving current I_{LED} may have a large error at the second frame period P_{F}.

Referring to FIG. 7B, as described above with reference to FIG. 5 and the like, the alternating current component may be generated based on the lower m-bit of the input signal IN, and accordingly, the first period P₁ may be much shorter than the period P_{PL} of the pulse signal PL regardless of an increase in the bit count of the input signal IN. Accordingly, the first period P₁ may be easily configured such that a multiple of the first period P₁ is equal to the frame period P_{F}. Also, even when the multiple of the first period P₁ is not equal to the frame period P_{F}, the LED driving current I_{LED} includes the direct current component and the alternating current component, and the alternating current component has a limited amplitude, and thus an error of the LED driving current I_{LED} may be insignificant. For example, as shown in FIG. 7B, even when the frame period P_{F} ends at a time t74 before the first period P₁ elapses from a time t73, the direct current component of the LED driving current I_{LED} is immediately changed and an effect of the alternating current component of the limited amplitude is insignificant, and thus the average of the LED driving current I_{LED} may barely have an error at the second frame period P_{F}.

FIGS. 8A and 8B are diagrams showing examples of the current generator 12 according to embodiments of the disclosure. As described above with reference to the drawings, current generators 80a and 80b of FIGS. 8A and 8B may receive the code CD and generate the LED driving current I_{LED}, based on the code CD. In FIGS. 8A and 8B, the bit count of the code CD may be z (z is an integer greater than 1). It should be noted that the current generator 12 of FIG. 1 is not limited by the examples of FIGS. 8A and 8B. Hereinafter, redundant descriptions will be omitted while describing FIGS. 8A and 8B.

Referring to FIG. 8A, the current generator 80a may include a reference current source CS8, an amplifier A, transistors M8 and M81 through M8z, and resistors R80 through R8z. The reference current source CS8 may generate a reference current I_{REF} from a second positive supply voltage VDD2, and a reference voltage V_{REF} may be generated by the reference current I_{REF} and the resistor R80. The amplifier A may maintain a source voltage of the transistor M8 to the reference voltage V_{REF} by adjusting a gate voltage of the transistor M8, and accordingly, the magnitude of the LED driving current I_{LED} may be determined according to the reference voltage V_{REF} and those of the resistors R81 through R8z, which are electrically connected to each other in parallel by the transistors M81 through M8z.

The transistors M81 through M8z may respectively receive the bits of the code CD. Each of the transistors M81 through M8z may be turned on in response to an activated bit, i.e., a bit having a value of one, and turned off in response to a deactivated bit, i.e., a bit having a value of zero. Accordingly, a transistor receiving an activated bit and a resistor connected to the transistor in series may function as a single current source. The code CD may indicate a binary value, and accordingly, the resistors R81 through R8z may have different resistances. For example, the resistance of the resistor R82 may be ½ of resistance of the resistor R81, and the resistance of the resistor R8z may be ½^{z-1} of resistance of the resistor R81. According to some embodiments, the resistor R80 and the resistor R81 may have a same resistance.

Referring to FIG. 8B, the current generator 80b may include the reference current source CS8, the amplifier A, transistors M8 and M80 through M8z, and switches SW1 through SWz. The transistor M8 may pass the reference current I_{REF} and include a gate having a bias voltage VB. Gates of the transistors M80 through M8z may be respectively connected to the switches SW1 through SWz controlled according to the code CD. Each of the switches SW1 through SWz may provide the bias voltage VB or ground potential to a gate of a corresponding transistor, according to a bit of the code CD. Accordingly, a transistor in which the bias voltage VB is applied to a gate, from among the transistors M80 through M8z, may function as a current source generating a current proportional to the reference current I_{REF}.

Each of the switches SW1 through SWz may provide the bias voltage VB to a transistor in response to an activated bit, i.e., a bit having a value of one, and provide the ground potential to a transistor in response to a deactivated bit, i.e., a bit having a value of zero. The code CD may indicate a binary value, and accordingly, the transistors M81 through M8z may have different current driving capabilities (or different sizes). For example, the current driving capability of the transistor M82 may be 2 times the current driving capability of the transistor M81, and the current driving capability of the transistor M8z may be 2^{z-1} times the current driving capability of the transistor M81. According to some embodiments, the transistor M80 and the transistor M81 may have a same current driving capability (i.e., size).

FIGS. 9A and 9B are diagrams showing examples of LED drivers according to embodiments of the disclosure. In detail, FIG. 9A illustrates the LED driver 90a including a code generator 91a, which performs operations of FIG. 3A, and FIG. 9B illustrates the LED driver 90b including a bit generator 91b, which performs operations of FIG. 3B. In FIGS. 9A and 9B, current generators 92a and 92b are simply illustrated as including a plurality of current sources that are enabled or disabled according to the bits of the code CD, and magnitudes of currents generated while the plurality of current sources are enabled are also illustrated. Hereinafter, redundant descriptions will be omitted while describing FIGS. 9A and 9B.

Referring to FIG. 9A, the LED driver 90a may include the code generator 91a and the current generator 92a. The code generator 91a may include an adder 91_1 and a bit generator 91_2. The bit generator 91_2 may receive the lower m-bit of the input signal IN, i.e., IN[m:1], and generate the bit signal B0. The adder 91_1 may add the upper n-bit of the input signal IN, i.e., IN[m+n:m+1], and the bit signal B0, and generate the code CD. Accordingly, the value of the code CD may be the upper n-bit of the input signal IN (i.e., IN[m+n:m+1]) or a value increased by 1 from the upper n-bit of the input signal IN (i.e., IN[m+n:m+1]+1). Accordingly, the bit count of the code CD may be (n+1).

The current generator 92a may include the amplifier A, a transistor M9, and (n+1) current sources CS0 through CSn. As shown in FIG. 9A, the current sources CS0 through CSn may generate currents of different magnitudes while being enabled. Accordingly, the LED driving current I_{LED} may have a magnitude corresponding to the value of the code CD.

Referring to FIG. 9B, the LED driver 90b may include the bit generator 91b and the current generator 92b. In the LED driver 90b of FIG. 9B, a code generator may include only the bit generator 91b, and the upper n-bit of the input signal IN, i.e., IN[m+n:m+1], may be used as an n-bit of the code CD, i.e., CD[n+1:2]. The bit generator 91b may receive the lower m-bit of the input signal IN, i.e., IN[m:1], and generate the bit signal B0. As shown in FIG. 9B, the bit signal B0 may be used as one bit of the code CD, i.e., CD[1], and accordingly, the bit count of the code CD may be (n+1).

The current generator 92b may include the amplifier A, the transistor M9, and the (n+1) current sources CS0 through CSn. As shown in FIG. 9B, the current sources CS0 through CSn may generate currents of different magnitudes while being enabled, and the current sources CS0 and CS1 respectively receiving a bit (CD[1]) and a bit (CD[2]) of the code CD may generate currents (i.e., I_{REF}) of a same magnitude. Accordingly, the LED driving current I_{LED} may have a magnitude corresponding to the value of the code CD. In other words, in the LED driver 90a of FIG. 9A, the bit signal B0 may be added with the upper n-bit of the input signal IN in the code generator 91a by the adder 91_1, and in the LED driver 90b of FIG. 9B, a current corresponding to the bit signal B0 may be added with a current corresponding to the upper n-bit of the input signal IN in the current generator 92b.

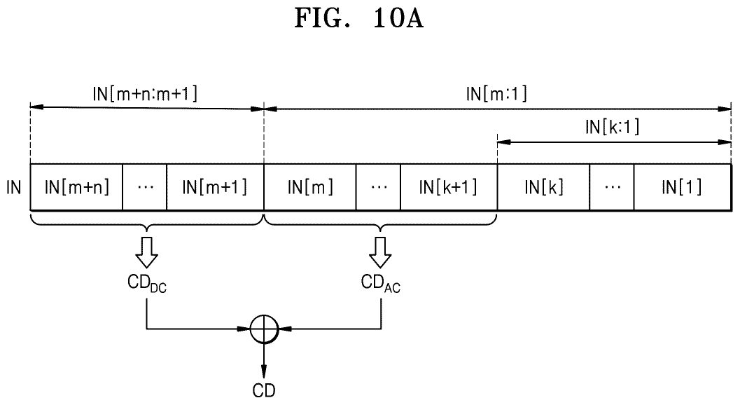

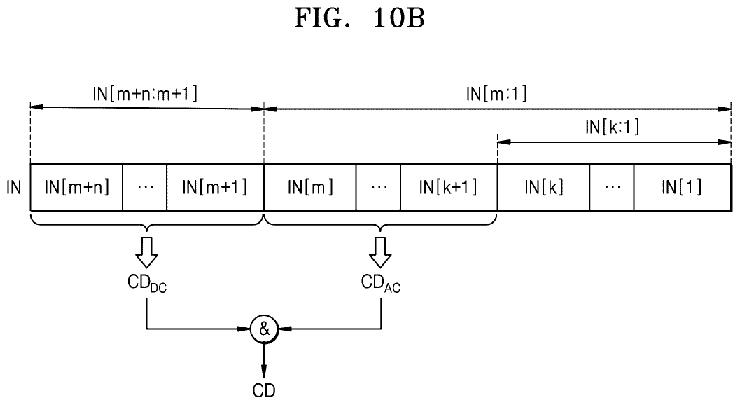

FIGS. 10A and 10B are diagrams showing examples of operations of the code generator 11, according to embodiments of the disclosure. As described above with reference to FIG. 1, the code generator 11 may generate the code CD from the input signal IN. Hereinafter, k may be a positive integer smaller than m. As described above with reference to FIGS. 3A and 3B, the first portion CD_{DC} and the second portion CD_{AC} may be added in FIG. 10A, or the first portion CD_{DC} and the second portion CD_{AC} may be concatenated in FIG. 10B. Hereinafter, descriptions overlapping those of FIGS. 3A and 3B will be omitted, and FIGS. 10A and 10B will be described with reference to FIG. 1.

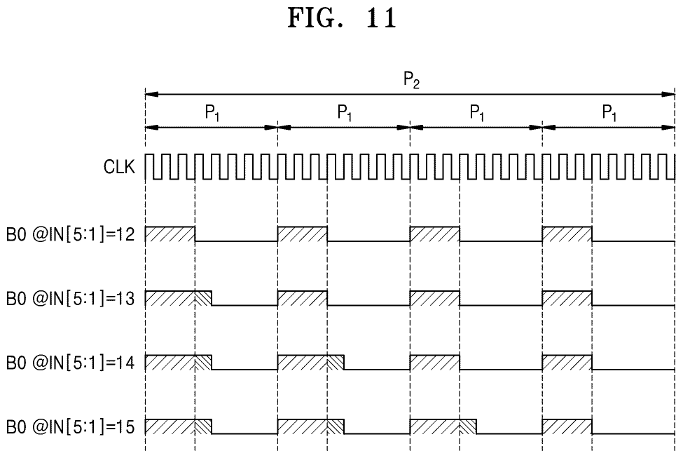

The code generator 11 may generate the code CD such that a pulse having a width changing based on the lower m-bit of the input signal IN is generated. For example, the code generator 11 may generate the code CD such that a pulse has a width including a constant portion corresponding to an upper (m-k)-bit among the lower m-bit of the input signal IN and a portion changing based on a lower k-bit of the input signal IN. For example, as shown in FIGS. 10A and 10B, the code generator 11 may generate the code CD such that a pulse has a width changing based on a value of the lower m-bit of the input signal IN, i.e., IN[[k:1] which is at least one bit including an LSB among IN[m:1]. Accordingly, as will be described below with reference to FIG. 11, extension of the first period P₁ may be prevented regardless of an increase in the dimming resolution.

FIG. 11 is a timing diagram showing an example of operations of the bit generator 11_1, according to an embodiment of the disclosure. In detail, in the timing diagram of FIG. 11, the code CD may be generated such that the pulse has a width changing based on the lower m-bit of the input signal IN, as described above with reference to FIGS. 10A and 10B. For convenience of illustration, m may be 5 and k may be 2 in FIG. 11. A second period P₂ may include four first periods P₁, and the bit generator 111 may generate the bit signal B0 iterated every second period P₂. It should be noted that the operations of the bit generator 11_1 are not limited by the example of FIG. 11. Hereinafter, FIG. 11 will be described with reference to FIG. 1.

Referring to FIG. 11, the bit generator 11_1 may generate the code CD such that the pulse has the width including the constant portion corresponding to the upper (m-k)-bit among the lower m-bit of the input signal IN and the portion changing based on the lower k-bit of the input signal IN. For example, when the lower m-bit of the input signal IN is 12, the pulse may have a uniform width corresponding to three cycles of the clock signal CLK, and accordingly, a sum of widths of pulses in the second period P₂ may correspond to 12 cycles of the clock signal CLK. When the lower m-bit of the input signal IN is 13, a pulse in the first period P₁ may have a width corresponding to four cycles of the clock signal CLK, whereas a pulse in each of the second, third, and fourth first periods P₁ may have a width corresponding to three cycles of the clock signal CLK. As a result, the sum of the widths of the pulses in the second period P₂ may have a width corresponding to 13 cycles of the clock signal CLK. Similarly, when the lower m-bit of the input signal IN is 14, a sum of widths of pulses in the second period P₂ may have a width corresponding to 14 cycles of the clock signal CLK, and when the lower m-bit of the input signal IN is 15, a sum of widths of pulses in the second period P₂ may have a width corresponding to 15 cycles of the clock signal CLK.

As described above with reference to FIG. 11, the LED driving current I_{LED} may be finely adjusted without having to extend the first period P₁ corresponding to 8 cycles of the clock signal CLK. As a result, the dimming resolution may be increased without having to extend the first period P₁.

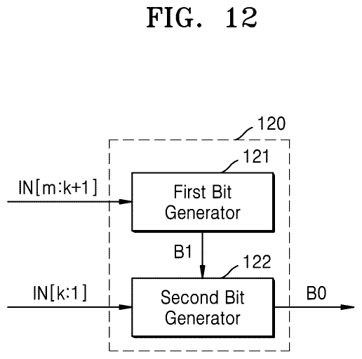

FIG. 12 is a diagram showing a bit generator 120 according to an embodiment of the disclosure. In detail, FIG. 12 illustrates the bit generator 120 generating the code CD such that the pulse has the width changing based on the lower m-bit of the input signal IN, as described above with reference to FIG. 11 and the like. As shown in FIG. 12, the bit generator 120 may include a first bit generator 121 and a second bit generator 122. Although not illustrated, the first bit generator 121 and the second bit generator 122 may commonly receive the clock signal CLK.

The first bit generator 121 may receive the upper (m-k)-bit among the lower m-bit of the input signal IN, i.e., IN[m:k+1], and generate a bit signal B1. For example, as described above with reference to FIGS. 4A and 4B, the first bit generator 121 may generate the bit signal B1 such that a pulse proportional to a value of IN[m:k+1] is generated in the first period P₁. In other words, the bit signal B1 corresponding to a constant portion among a changing pulse width may be generated.

The second bit generator 122 may receive the bit signal B1 and the lower k-bit among the lower m-bit of the input signal IN, i.e., IN[k:1], and generate the bit signal B0. The second bit generator 122 may bypass the bit signal B1 to the bit signal B0 or set the bit signal B0 to 1, based on a value of IN[k:1], when the bit signal B1 transitions from 1 to zero every first period P₁. Accordingly, as described above with reference to FIG. 11, pulses having changing widths may be generated, and the LED driving current I_{LED} may be further finely adjusted.

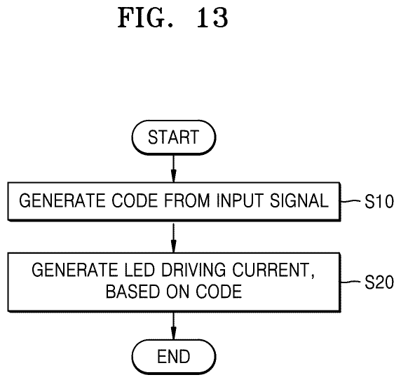

FIG. 13 is a flowchart of a method for high-resolution dimming, according to an embodiment of the disclosure. As shown in FIG. 13, the method for high-resolution dimming may include operations S10 and S20. According to some embodiments, the method of FIG. 13 may be performed by the LED driver 10 of FIG. 1. Hereinafter, FIG. 13 will be described with reference to FIG. 1.

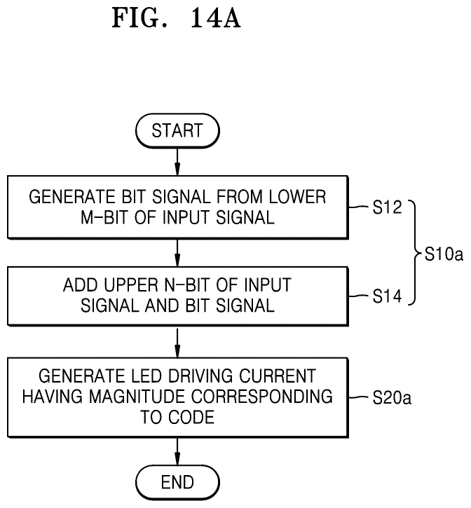

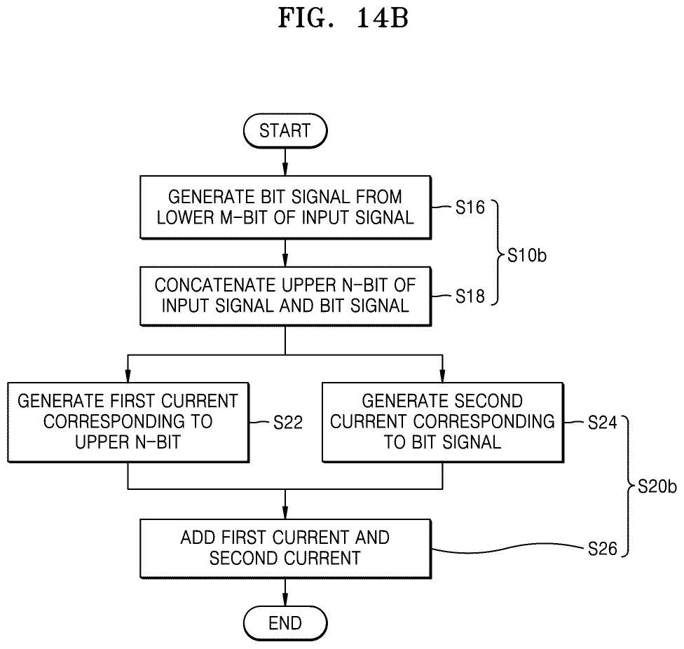

Referring to FIG. 13, in operation S10, the code CD may be generated from the input signal IN. For example, the code generator 11 may generate the code CD such that the LED driving current I_{LED} includes the direct current component corresponding to the upper n-bit of the input signal IN, and the alternating current component corresponding to the lower m-bit of the input signal IN. As described above with reference to the drawings, the code CD may indicate the magnitude of the LED driving current I_{LED} during the first period P₁ or second period P₂. Examples of operation S10 will be described below with reference to FIGS. 14A and 14B.

In operation S20, the LED driving current I_{LED} may be generated based on the code CD. For example, the current generator 12 may receive the code CD generated in operation S10, and generate the LED driving current I_{LED}, based on the code CD. The current generator 12 may have a simple structure and a small area, according to the bit count of the code CD which is smaller than the bit count of the input signal IN. Examples of operation S20 will be described below with reference to FIGS. 14A and 14B.

FIGS. 14A and 14B are flowcharts of exemplary methods for high-resolution dimming, according to embodiments of the disclosure. According to some embodiments, the method of FIG. 14A may be performed by the LED driver 90a of FIG. 9A, and the method of FIG. 14B may be performed by the LED driver 90b of FIG. 9B. Hereinafter, FIGS. 14A and 14B will be described with reference to FIGS. 9A and 9B.

Referring to FIG. 14A, the method for high-resolution dimming may include operations S10a and S20a. According to some embodiments, operations S10a and S20a may be examples of operations S10 and S20 of FIG. 13, respectively. Operation S10a may include operations S12 and S14.

In operation S12, the bit signal B0 may be generated from the lower m-bit of the input signal IN. For example, the bit generator 91_2 of FIG. 9A may generate the bit signal B0 from the lower m-bit of the input signal IN, i.e., IN[m:1], based on the clock signal CLK. The bit signal B0 may include 1s and the number of 1s may correspond to a value of the lower m-bit of the input signal IN in the first period P₁.

In operation S14, the upper n-bit of the input signal IN and the bit signal B0 may be added. For example, the adder 91_1 of FIG. 9A may add the upper n-bit of the input signal IN, i.e., IN[m+n:m+1], and the bit signal B0, and accordingly, the code CD of (n+1)-bit may be generated.

In operation S20a, the LED driving current I_{LED} having a magnitude corresponding to the code CD may be generated. For example, the current generator 92a of FIG. 9A may include the current sources that generate currents of different magnitudes and are enabled by the bits of the code CD, respectively, and accordingly, the LED driving current I_{LED} having a magnitude proportional to the value of the code CD may be generated.

Referring to FIG. 14B, the method for high-resolution dimming may include operations S10b and S20b. According to some embodiments, operations S10b and S20b may be examples of operations S10 and S20 of FIG. 13, respectively. Operation S10b may include operations S16 and S18, and operation S20b may include operations S22, S24, and S26.

In operation S16, the bit signal B0 may be generated from the lower m-bit of the input signal IN. For example, the bit generator 91b of FIG. 9b may generate the bit signal B0 from the lower m-bit of the input signal IN, i.e., IN[m:1], based on the clock signal CLK. The bit signal B0 may include 1s and the number of 1s may correspond to the value of the lower m-bit of the input signal IN in the first period P₁.

In operation S18, the upper n-bit of the input signal IN and the bit signal B0 may be concatenated. For example, code CD may include the bit signal B0 and the upper n-bit of the input signal IN, i.e., IN[m+n:m+1], and accordingly, the code CD of (n+1)-bit may be generated.

In operation S22, a first current corresponding to the upper n-bit of the input signal IN may be generated, and in operation S24, a second current corresponding to the bit signal B0 may be generated. For example, in the current generator 92b of FIG. 9B, the current sources CS1 through CSn may generate the first current corresponding to the upper n-bit of the input signal IN, and the current source CS0 may generate the second current corresponding to the bit signal B0.

In operation S26, the first current and the second current may be added. For example, the current generator 92b of FIG. 9B may generate the LED driving current I_{LED} by adding the first current generated in operation S22 and the second current generated in operation S24.

Hereinabove, embodiments have been described in the drawings and specification. In the present specification, although the embodiments have been described by using specific terms, the terms are used only for descriptive purposes and are not intended to limit the meanings or scope of the disclosure described in the claims. Therefore, it will be understood by one of ordinary skill in the art that other modifications and equivalents may be made therein. Accordingly, the scope of the disclosure will be defined by the appended claims.

According to an LED driver, a light-emitting module, and a display device, according to embodiments of the disclosure, resolution of dimming may be increased and accordingly, performance of an application including an LED may be increased.

Also, according to an LED driver, a light-emitting module, and a display device, according to embodiments of the disclosure, the area required for high-resolution dimming may be reduced and accordingly, efficiency of an application including an LED may be increased.

Effects achieved from the embodiments of the disclosure are not limited to those described above, and other effects that are not described may be clearly derived and understood by one of ordinary skill in the art. In other words, unintended effects according to the embodiments of the disclosure may be derived by one of ordinary skill in the art.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A light-emitting diode (LED) driver configured to generate an LED driving current based on an input signal, the LED driver comprising:
a code generator configured to generate a code such that the LED driving current includes a direct current component corresponding to an upper n-bit of the input signal and an alternating current component alternating according to a lower m-bit of the input signal; and
a current generator configured to generate the LED driving current based on the code,
wherein the input signal is an (m+n)-bit signal when each of m and n is an integer greater than zero.

2. The LED driver of claim 1, wherein the alternating current component includes at least one pulse during a first period according to the lower m-bit, and
the code generator includes a bit generator configured to generate a bit signal defining the at least one pulse from the lower m-bit, based on a clock signal.

3. The LED driver of claim 2, wherein a sum of widths of the at least one pulse is constant for each first period.

4. The LED driver of claim 2, wherein a sum of widths of the at least one pulse changes during a second period including two or more first periods.

5. The LED driver of claim 4, wherein the sum of widths of the at least one pulse includes a first portion that changes according to a lower k-bit among the lower m-bit, and a second portion that is constant according to an upper (m-k)-bit among the lower m-bit.

6. The LED driver of claim 2, wherein the code generator further includes an adder configured to generate a code of (n+1)-bit by adding the upper n-bit and the bit signal.

7. The LED driver of claim 2, wherein the code includes the upper n-bit and the bit signal,
the current generator further includes:
a first current source configured to generate a first current corresponding to the upper n-bit; and
a second current source configured to generate a second current corresponding to the bit signal, and
the LED driving current corresponds to a sum of the first current and the second current.

8. A method of driving a light-emitting diode (LED) based on an input signal, the method comprising:
generating a code such that an LED driving current includes a direct current component corresponding to an upper n-bit of the input signal and an alternating current component alternating according to a lower m-bit of the input signal; and
generating the LED driving current based on the code,
wherein each of n and m is an integer greater than zero, and the input signal is an (n+m)-bit signal.

9. The method of claim 8, wherein the alternating current component includes at least one pulse during a first period according to the lower m-bit, and
the generating of the code further comprises generating a bit signal defining the at least one pulse from the lower m-bit based on a clock signal.

10. The method of claim 9, wherein the generating of the code further comprises adding the upper n-bit and the bit signal.

11. The method of claim 9, wherein the generating of the code further comprises generating the code by concatenating the upper n-bit and the bit signal, and
the generating of the LED driving current comprises:
generating a first current corresponding to the upper n-bit;
generating a second current corresponding to the bit signal; and
adding the first current and the second current.
